(19) United States
(12) Patent Application Publication
(10) Pub. No.: US 2024/0351960 A1
(43) Pub. Date: Oct. 24, 2024

(54) METHOD FOR PRODUCING PHOSPHORYL OR THIOPHOSPHORYL TRIAMIDE, AND USE OF COMPOUND IN NITROGEN FERTILIZER FORMULATIONS

(71) Applicant: NOVAEM BBTRADE, Bordeaux (FR)

(72) Inventors: Bernard BEAL, La Rochelle (FR); Eric BELLEPERCHE, Saint-Jean D'Angely (FR); Bruno MONTAGNIER, Marseille (FR)

(21) Appl. No.: 18/495,079

(22) PCT Filed: Apr. 27, 2022
(86) PCT No.: PCT/IB2022/053887

§ 371 Date: Oct. 26, 2023

(30) Foreign Application Priority Data
Apr. 27, 2021 (FR) 2104347

(51) Int. Cl. C05G 3/90; C01B 21/097; C05C 9/00

(52) U.S. Cl. CPC C05G 3/90; C01B 21/097; C05C 9/00

(57) ABSTRACT

A method for producing phosphoryl triamide OP(NH₂)₃ or thiophosphoryl triamide SP(NH₂)₃, in which: a) phosphoryl trichloride OPCl₃ or thiophosphoryl trichloride SPCl₃, respectively, is reacted with gaseous ammonia in an apolar liquid phase to give a first precipitate comprising, respectively, phosphoryl triamide or thiophosphoryl triamide, and ammonium chloride, and b) the first precipitate is treated with sodium carbonate or potassium carbonate, in a polar organic liquid phase, to give a second precipitate comprising NaCl and the phosphoryl triamide or thiophosphoryl triamide remaining in said polar organic liquid phase, and the second precipitate is separated from the polar organic liquid phase, the latter possibly undergoing a further concentration step to enrich it in phosphoryl triamide or thiophosphoryl triamide.

### CROSS-REFERENCE TO RELATED APPLICATION

The present application is a National Stage Application of PCT International Application No. PCT/IB2022/053887 (filed on Apr. 27, 2022), under 35 U.S.C. § 371, which claims priority to French Patent Application No. FR 2104347 (filed on Apr. 27, 2021), which are each hereby incorporated by reference in their complete respective entireties.

### TECHNICAL FIELD

The invention relates to the field of synthetic organic chemistry, and more particularly to the synthesis of phosphoryl triamide (abbreviated PTA, Phosphoryl Tri Amide) or its thio homolog (abbreviated TPTA, Thio Phosphoryl Tri Amide). It presents a new simple and ecological process to obtain this compound in a highly enriched form, and in particular in the form of a mixture enriched in phosphoryl triamide and depleted in chlorides.

The invention also relates to the field of agrochemistry, and more particularly to the use of such a mixture enriched in PTA or TPTA and depleted in chlorides in formulations of nitrogenous fertilizers, and in particular in solid formulations of urea-based fertilizers, with the aim of inhibiting urease in order to limit ammonia losses by volatilization and thus increase the actual coefficient of use of the nitrogenous fertilizer.

### STATE OF THE ART

A method of synthesizing PTA from OPCl₃ and NH₃ in cold chloroform is known, described in Inorganic Syntheses, Vol VI, ed. E. G. Rochow, 1960, p. 108. This synthesis generates NH₄Cl as a side product. A similar synthesis was described in 1954 by R. Klemm and O. Koch in the journal Chemische Berichte vol. 87, p. 333-340. According to this process, a solution of NH₃ in chloroform maintained at −10° C. is first introduced into a reactor, and a solution of OPCl₃ in chloroform is added drop by drop, while maintaining a flow of NH₃ through the liquid phase to ensure a surplus of NH₃. However, this synthesis is difficult to control and to industrialize, insofar as the reaction is exothermic and any untimely increase in temperature risks leading to an increase in the NH₃ pressure in the reactor.

Different methods have been proposed to subsequently separate the NH₄Cl from the PTA. The method described in Rochow's book uses diethylamine NH(C₂H₅)₂; this reaction generates NH₃ which is reused. However, diethylamine is a flammable and quite toxic compound that one would like to avoid. The Klemm and Koch method proceeds by fractional crystallization from methanol.

One can also proceed by washing with cold or hot water which dissolves the NH₄Cl (see Comprehensive Treatise on Inorganic and Theoretical Chemistry, ed. Mellor, vol. 8, p. 713, published in 1947); this is not an industrial method either, because an aqueous liquid effluent is thus obtained which carries with it part of the PTA. U.S. Pat. No. 2,661,264 (Monsanto) proposes a methanol wash which dissolves NH₄Cl; even though methanol can be easily distilled, its toxicity makes it undesirable for an industrial process.

U.S. Pat. No. 2,596,935 describes the use of the partially polymerized product resulting from the OPCl₃+NH₃ reaction as a fertilizer. NH₄Cl, a side product of the reaction, was removed by leaching with water.

Certain derivatives of phosphoric and thiophosphoric triamides and their oligomers or polymers have been explored with a view to their use in the field of agriculture, and more specifically as fertilizers and as urease inhibitors.

At the global level, nitrogen fertilizers based on urea are the main nitrogen fertilizer with an overall annual volume of around 180 million tonnes; only in some countries do ammonium nitrate products containing either 33.5% of ammonium nitrate (which present an explosion hazard) or 27% of ammonium nitrate in the form of calcium ammonium nitrate (inert) exceed urea. Urea is commonly used in the form of granules with a diameter of between approximately 2 mm and approximately 4 mm, typically containing approximately 46% by mass of nitrogen, or in the form of a nitrogenous solution which may contain, in addition to urea, ammonium nitrate.

The major disadvantage of urea is the volatilization of ammonia, which results from the action of the enzyme urease, and which leads to significant losses of nitrogen, to atmospheric pollution linked to ammonia, and to the eutrophication of natural environments. The European Union, like other countries in the world, seeks to reduce the emission of ammonia into the atmosphere. In Europe, the use of mineral fertilizers represents approximately 22% of ammonia emissions, 80% of which come from mineral fertilizers, knowing that 75% of ammonia emissions come from livestock farming.

To mitigate the emission of ammonia from nitrogenous fertilizers, the use of urease inhibitors is one way among others (such as burying the fertilizer, coating the grains for delayed release, and irrigation following nitrogen fertilizer application). With regard to urease inhibitors, their ecotoxicological assessment must however be taken into account insofar as they are synthetic products.

WIPO Publication No. WO 2009/079994 (Fertiva) describes urea-based fertilizers comprising thiophosphoryl triamine derivatives, such as N-(n-butyl) thiophosphoric triamide (abbreviated nNBPT or simply NBPT) and N-(n-propyl)-thiophosphoric triamide (abbreviated nNMP). WIPO Publication No. WO 00/58317 and EP 1 163 245 (SKW Stickstoffwerke Piesteritz) describe the inhibition of urease by compounds of the OP (NH₂)₂(NHR²) type with a complex R² group. Urease is an enzyme that catalyzes the transformation of urea into carbon dioxide and ammonia (which can react to form ammonium, a highly water-soluble cation); it is present in a large number of bacteria, yeasts and plants. In soil fertilized with a urea-based fertilizer, urease hydrolyzes urea which turns into NH₄+. During this transition, part of the nitrogen flies away in the form of gaseous ammonia. The NH₄⁺ molecule is then transformed by Nitrosomonas and Nitrobacter (two soil bacteria) into nitrate (NO₃⁻) which can be easily leached, and which will therefore be lost for soil fertilization: this natural process reduces the quantity of nitrogen available as fertilizer. The two patent documents mentioned describe a urea-based fertilizer to which these molecules are added as a urease inhibitor to prevent the loss of part of the urea.

U.S. Pat. No. 4,676,822 (Tennessee Valley Authority) describes a urease inhibiting effect for the triophosphoryl triamide SP(NH₂)₃ (abbreviated TPTA). China Patent Publication No. CN 101 434503 A describes a synergistic effect between PTA or TPTA and polyaspartic acid for this urease inhibiting effect.

C. B. Christianson, B. H. Byrnes & G. Carmona, in a publication entitled “A comparison of the sulfur and oxygen analogs of phosphoric triamide urease inhibitors in reducing urea hydrolysis and ammonia volatilization”, published in the journal Fertilizer Research 26, 21-27, 1990, compare different complex molecules derived from phosphoryl triamide or from thiophophoryl triamide, namely the thio derivatives nBTPT and its cyclohexyl analogue (abbreviated CHTPT), and the oxygen analogue derivatives (nBPT and CHPT). They postulate that in the soil, thiophosphoryl molecules are transformed into their analogous phosphoryl form, i.e. by replacement of sulfur by oxygen. This process depends on the nature and chemistry of the soil and takes time, during which urease is not sufficiently inhibited. The authors raise the problem of the stability of these molecules in the ground, as well as the problems of the cost of these molecules, and the way of incorporating them in a solid nitric fertilizer.

The hypothesis of Christianson et al. on the transformation of the thio form into its oxo form in soils has been demonstrated by Danièle Pro, for molecules similar to those used by these authors, in her doctoral thesis entitled “Development of new urease and nitrification inhibitors for phytosanitary purposes” (Ecole Nationale Supérieure de Chimie de Rennes, Nov. 4, 2011); this work also postulates a reaction mechanism for the acid hydrolysis of these molecules, a phenomenon that limits their effectiveness in a humid environment, and which must be taken into account during the storage of solid fertilizer added with urease inhibitor, as well as during its spreading on a field.

Practical problems which have been described in relation to urease inhibitors include in particular the coating of fertilizer grains with the urease inhibitor additive from a liquid, by vaporization or impregnation, or from a solid powder by dusting, as described in WIPO Publication No. WO 2009/079994; in any event, this is an additional industrial process which can present a certain complexity if one wishes to achieve a homogeneous distribution of the additive in the mass of fertilizer to be treated. When a solid fertilizer is impregnated with a liquid containing a urease inhibitor additive, this fertilizer must not lose its properties as a dry granular solid: the liquid phase must be as concentrated as possible, while allowing it to be spread easily and homogeneously on the stock of fertilizer. This also makes it possible to minimize the quantity of additive to be supplied and handled, which is desirable in order to simplify the use of this additive, and to minimize its environmental impact.

Another problem with urease inhibitors is their ecotoxicity. For example, in certain countries such as France, urease inhibitors cannot be homologated, and in particular NBPT, mentioned above, is not currently considered there as a satisfactory product from an ecotoxicological point of view. Its use can only be done thanks to an extension of the EC fertilizer standard. These complex organic derivatives of TPA are also quite expensive, and their synthesis leads to a mixture of products, among which we often find dimers and oligomers.

Insofar as the problem of the volatilization of urea by urease still does not have a solution which would be completely satisfactory from a technical, economic and ecological point of view, the present invention aims to propose new preparations of urease inhibitors, which are not very toxic, which can be incorporated in a simple and practical manner into a solid nitrogen fertilizer, and which are not expensive. And finally, we want the manufacturing process of the urease inhibitor preparation to have as low an ecological impact as possible, which prohibits the use of toxic auxiliary products, as well as processes that discourage the use of processes that generate secondary products that must be treated in a specific way.

### SUMMARY

Thus, a first object of the invention is a method for the manufacture of phosphoryl triamide OP(NH₂)₃ or thiophosphoryl triamide SP(NH₂)₃ in which:
a) phosphoryl trichloride OPCl₃ or thiophosphoryl trichloride SPCl₃ is reacted, respectively, with gaseous ammonia in an apolar liquid phase to obtain a first precipitate comprising phosphoryl triamide and ammonium chloride, and
b) said first precipitate is treated with sodium carbonate or potassium carbonate, preferably with sodium carbonate, in a polar organic liquid phase, to obtain a second precipitate comprising NaCl, knowing that the phosphoryl triamide or the thiophosphoryl triamide, respectively, remain in said polar organic liquid phase, and said second precipitate is separated from said polar organic liquid phase.

The latter can undergo a further concentration step to increase its phosphoryl triamide concentration, for example by partial evaporation of said polar organic liquid phase.

In one variant, a step c) is added in which said organic liquid phase obtained at the end of step b) is evaporated to obtain a third precipitate comprising, respectively, phosphoryl triamide or thiophosphoryl triamide.

Said sodium carbonate or potassium carbonate is preferably anhydrous.

Said first precipitate typically has a phosphoryl triamide or thiophosphoryl triamide mass fraction of at least 15%, preferably at least 22%, and even more preferably at least 28%; this simplifies the purification step (step b).

Another object of the invention is the product obtainable by the method described above and comprising steps a) and b), said product being said third precipitate. This precipitate has a high concentration of PTA or TPTA, with a specific spectrum of impurities. Advantageously, said third precipitate has a mass fraction of PTA or TPTA of at least 70%, preferably of at least 80%, and even more preferably of at least 90%; depending on the reaction conditions, said concentration of PTA or TPTA can exceed 90% by mass, and can reach 92%, 94% or even 96%.

Yet another object of the invention is the use of said polar organic liquid phase obtained at the end of step b), possibly diluted, for coating or impregnating granules of nitrogen fertilizer, preferably based on urea, to inhibit and/or regulate the loss of nitrogen from a nitrogen fertilizer, in particular to inhibit and/or regulate the enzymatic hydrolysis of urea, and/or to inhibit and/or regulate the microbiological oxidation of ammonium.

Yet another object of the invention is a method for preparing a so-called stabilized solid nitric fertilizer formulation, in which a solid nitric fertilizer is provided and is impregnated with a liquid phase which is said polar organic liquid phase obtained at the end of step b), possibly diluted, or which is obtained by complete dissolution of said third precipitate in water.

Advantageously, said liquid phase is used in a quantity which does not exceed 3 L of liquid per tonne of fertilizer, preferably does not exceed 2.5 L per tonne of fertilizer, and even more preferably does not exceed 2 L per tonne of fertilizer. This does not alter the properties (in particular the rheological properties) of the granular solid of the fertilizer, and does not affect its storage stability.

### DESCRIPTION

The abbreviation “PTA” here designates phosphoryl triamide (CAS no. 13597-72-3) with the formula O═P(NH₂)₃. We prefer here the simplified writing OP(NH₂)₃ to the more common writing PO(NH₂)₃ because it better represents the structure of the molecule. The same remark applies to the writing of the formula of the molecule O═PCl₃ and to the thio homologs of these two molecules. The abbreviation “TPTA” designates here the thiophosphoryl triamide of formula S═P(NH₂)₃.

Unless otherwise stated, all the values given in percent in a composition or formulation are percent by mass.

The PTA manufacturing method according to the invention comprises two steps.

The first step is known as such: phosphorus oxychloride OPCl₃ is reacted with gaseous ammonia at the interface of the apolar liquid phase to obtain a first precipitate comprising PTA and ammonium chloride. This reaction typically takes place at a temperature below 20° C., preferably between −20° C. and 20° C., and even more preferably between −10° C. and 5° C. Said apolar liquid phase advantageously comprises anhydrous chloroform as solvent. Any trace of water in the reaction medium risks promoting the hydrolysis of phosphoryl chloride to phosphoric acid.

Advantageously, the gaseous NH₃ is introduced into a reactor in which said apolar liquid phase and the OPCl₃ are located. Thus is formed, by a liquid/gas interfacial reaction, the PTA which represents, with the secondary product NH₄Cl, the first precipitate. The introduction of gaseous NH₃ into the reactor is industrially easy to carry out, and allows good control of the reaction, which can be stopped at any time without danger of explosion or release of ammonia, the ammonia being rapidly consumed by the reaction with phosphorus oxychloride.

In an advantageous embodiment, said apolar liquid phase is chloroform, preferably anhydrous. It can be easily recycled, and can in particular be reused in this first step of the method. By way of example, the NH₃ gas can be introduced, preferably with an overpressure of the order of 0.1 bar to 0.3 bar, into the reactor in which the chloroform and the phosphorus oxychloride are located, preferably at a temperature between approximately 2° C. and 6° C.

The separation of said first precipitate can be done with known methods, in particular by filtration or centrifugation. The product represented by the first precipitate advantageously comprises at least 15% by weight of PTA; this supposes in particular the use of an anhydrous apolar solvent and to work at a temperature not exceeding 20° C. Advantageously, the mass fraction of PTA is at least 22% or even at least 28%; it can typically reach about 35%.

It is not advantageous to use this first precipitate as it is as a preparation of urease inhibitor in a nitrogenous fertilizer, because it comprises a large quantity of ammonium chloride, highly soluble, the anion of which is undesirable in an agricultural soil, and the cation, a nitrogen carrier, difficult to assimilate by certain plants. Furthermore, to dissolve this first precipitate which contains a high concentration of ammonium chloride, a fairly large quantity of water must be used, which will entail the need to impregnate the fertilizer with a quantity of liquid greater than 4 liters per ton of fertilizer treated, which is not desirable.

The method according to the invention comprises a second step which aims to separate the PTA from the ammonium chloride. In this step, called here “step b)”, said first precipitate is treated first with a polar organic liquid phase (such as methanol or ethanol), to dissolve it. This is advantageously done under stirring, until a homogeneous suspension is obtained. Next, sodium carbonate, preferably anhydrous, is added to this liquid phase, still under stirring. This operation can take place at room temperature. A second precipitate is thus obtained. The latter mainly comprises NaCl; the PTA remaining in said polar organic liquid phase. Said second precipitate is separated from said polar organic liquid phase with known separation methods, which may be filtration.

During this second step, the addition of sodium carbonate leads to the reaction NH₄Cl+Na₂CO₃→NH₃(g)+NaCl(s)+NaHCO₃(s), which takes place in suspension, preferably under stirring; the duration of this reaction can be several hours, typically between 1 h and 20 h. At room temperature, the reaction time is advantageously between 1 h and 10 h, preferably between 2 h and 6 h. In all cases, the gaseous NH₃ is recovered which can be reintroduced into the step of the method according to the invention. It is noted that the sodium carbonate used during this step b) is an inexpensive and non-toxic commodity product.

The polar organic liquid phase containing the PTA can undergo a further concentration step to increase its PTA concentration, for example by partial evaporation of said polar organic liquid phase.

In one variant, a step c) is added in which said organic liquid phase obtained at the end of step b) is evaporated until a third precipitate comprising PTA is obtained. Alternatively (step c1)), the PTA can also be separated from said organic liquid phase by cold recrystallization, or it can be precipitated by adding chloroform, followed by filtration and drying of the residue (step c2)).

Advantageously, said polar liquid phase is ethanol, which is a common solvent, low in toxicity, not too volatile, easy to recover and to purify. Preferably, it is used in the method according to the invention in its anhydrous form. It is also possible to use methanol, preferably anhydrous, which is more toxic and more volatile, but which dissolves the first precipitate better.

The PTA obtained at the end of the second step has a good purity. The main impurities are the hydrolysis products of PTA, in particular OP(NH₂)₂OH (which can be easily identified on an NMR spectrum centered on the ³¹P isotope), dimers or oligomers of PTA, and other derivatives of PTA. These typical impurities partly also show urease inhibiting activity. However, it is preferred to minimize the level of impurities in such a product, because the behavior of the impurities is not necessarily the same as that of the targeted product.

Typically, said third precipitate has a mass fraction of phosphoryl triamide of at least 70%, preferably of at least 80%, and even more preferably of at least 90%; one can reach a content that exceeds 94%, and even 96%. In particular, the implementation of steps c1) and c2) facilitates the production of a third precipitate which comprises PTA with a purity greater than 90%.

The third precipitate resulting from the method according to the invention can be used, as it is or diluted in a solid material, in a solid formulation of nitrogenous fertilizer, preferably based on urea, to inhibit and/or regulate the loss of nitrogen from a nitrogenous fertilizer, in particular to inhibit and/or regulate the enzymatic hydrolysis of urea, and/or to inhibit and/or regulate the microbiological oxidation of ammonium.

The product according to the invention is preferably in the form of said third precipitate or in the form of said apolar liquid phase. As indicated above, it is enriched in PTA and depleted in chloride. This has various advantages. Introducing chloride to agricultural soil is generally undesirable.

The applicant has found that a quantity of PTA of the order of 0.05% to 0.3%, preferably between 0.05% and 0.2%, incorporated into a urea-based fertilizer, significantly reduces the production of ammonia.

The addition of the urease inhibitor in a solid formulation of nitrogen fertilizer can be done with an inhibitor which is in the form of a solid phase (preferably powder) or in the form of a liquid phase (generally in the form of a solution).

The addition of the solid inhibitor requires particularly efficient mechanical mixing means. The powdered inhibitor can be diluted in another solid additive, or in a quantity of granular fertilizer, before adding it to the volume of fertilizer to be treated.

The addition of the inhibitor as a liquid phase can be done by directly using the polar organic liquid phase resulting from the second step of the method, after separation of the NaCl; it is also possible to dilute the polar organic liquid phase resulting from the second step of the method according to the invention, if this is desired for any reason. Even if the solubility of PTA in ethanol is good, this approach consisting in using an alcoholic solution is not preferred because it requires managing in the workshop in which this impregnation is carried out a risk of explosion linked to gas, which the fertilizer industry is not used to.

Alternatively, a liquid phase laden with PTA can be obtained by dissolving said third precipitate, which comprises a high proportion of solid PTA, in a suitable solvent, which is preferably aqueous.

The addition of a liquid phase comprising a urease inhibitor to a solid nitrogenous fertilizer is usually done by impregnating said solid fertilizer, which is typically in granular form, with said liquid phase; said liquid phase is preferably applied by spraying. The quantity of this liquid phase is critical: in general, it is not desired to impregnate a solid formulation of nitrogenous fertilizer with more than 3 L of liquid per ton of fertilizer, so that said solid formulation does not lose its character of dry granular solid. It is preferred that this quantity does not exceed 2.5 L per ton, and even more preferably it does not exceed 2 L per ton. This objective can only be achieved if the urease inhibitor initially presents itself in the liquid phase in a fairly concentrated form. This is impossible to achieve if the first precipitate is used, which typically contains only around twenty or around thirty percent of PTA next to the major product represented by ammonium chloride: it would be necessary to apply rather 5 or 10 liters of solution per ton to obtain a target concentration of PTA of approximately 0.1% compared to the total quantity of fertilizer.

The problem of liquid quantity is exacerbated in the case of water, since urea-based fertilizers are sensitive to moisture. The standards generally tolerate a maximum of 0.5% humidity. Adding five or ten liters of liquid may lead to exceeding this standard. And finally, to treat 180 million tons of nitrogen fertilizers per year worldwide, it would be necessary to provide approximately 10 to 20 million liters of diluate (PTA+water), which poses a certain logistical problem.

However, the solubility of PTA in water is better than in a polar organic solvent such as ethanol. It is for this reason that the method for manufacturing PTA according to the invention is very advantageous, since it results in a product that is fairly concentrated in PTA, which makes it possible to minimize the quantity of solvent necessary to put it into solution and apply it to the fertilizer, insofar as the solvation of the PTA is not disturbed by the solvation of secondary products.

By way of example, it is possible to advantageously use an aqueous solution obtained by complete dissolution of the third precipitate, comprising a PTA content greater than 85% and preferably greater than 88%, and even more preferably of at least 90%, at a rate of at most 3 L of liquid per tonne of fertilizer, and preferably of at most 2.5 L of liquid per tonne, and even more preferably of at most 2 L of liquid per tonne. In this embodiment, the concentration of PTA in the fertilizer is preferably between 0.05% and 0.3%, more preferably between 0.05% and 0.2%; a concentration of about 0.1% gives good results.

In any case, the addition of such an aqueous solution to a solid fertilizer can be done at room temperature. Adding such a small amount of liquid to a solid, granular fertilizer does not alter its rheological properties, and it does not need to be dried before use. This avoids unnecessary energy expenditure.

The addition of a liquid phase comprising a urease inhibitor to a liquid nitrogen fertilizer does not raise any particular problem.

According to another variant, the third precipitate can be added in solid form to a solid or liquid nitrogen fertilizer. The addition of the third precipitate to a solid nitrogen fertilizer can be done by any appropriate means, for example using a mixing screw.

The invention can also be carried out with the thiophosphoryl triamide SP(NH₂)₃ (abbreviated TPTA), synthesized from thiophosphoryl trichloride SPCl₃ (CAS No. 3982-91-0) by following the same reaction as that described for PTA, and by following the same purification route; for each of these steps, it is possible to use operating conditions very similar to those described for the PTA. The TPTA can be used in the same way as the PTA. It has two major disadvantages compared to PTA: its very unpleasant smell, and the fact that thiophosphoryl trichloride is more expensive than phosphoryl trichloride.

### EXAMPLES

### Example 1: Synthesis and Purification of Phosphoryl Triamide (PTA)

The first step is the synthesis according to the formula 6NH₃(g)+OPCl₃(g)→3NH₄Cl(s)+OP(NH₂)₃(s). About 300 ml of anhydrous chloroform (CAS no.: 67-66-3, molar mass 119.38 g/mol, supplier: Sigma Aldrich (ref: 372978)) was introduced into a one-liter three-necked flask (two necks being fitted with a septum, and the third neck fitted with a balloon) previously purged with argon. Then 10 g of phosphoryl trichloride (POCl₃, CAS No. 10025-87-3, molar mass 153.33 g/mol, supplier Sigma Aldrich (ref: 201170)) were added using a syringe through a septum. The flask was placed in an ice bath with stirring. When the contents were well cooled, gaseous ammonia (CAS no.: 7664-41-7, molar mass 17.03 g/mol, supplier Sigma Aldrich (ref: 294993)) was introduced very slowly using a cannula through the septum. A white precipitate appeared in the chloroform phase. The reaction is complete when the balloon stays inflated.

The white precipitate was recovered by filtration on a frit. The white precipitate is a mixture of NH₄Cl and PTA. After drying the white precipitate, the reaction yield was approximately 96% to 98% relative to the POCl₃ consumed.

The white precipitate obtained in the first step was partially dissolved in anhydrous ethanol (CAS No. 64-17-5) at room temperature. Anhydrous Na₂CO₃ (CAS No. 497-19-8) was added with a 1:1 molar ratio relative to the NH₄Cl. The mixture was left under stirring for 12 hours, then the mixture was filtered to remove NaCl and NaHCO₃ from the solution. The filtrate is a solution of ethanol with PTA. After evaporation of the ethanol from the filtrate, a white solid remains with a PTA concentration of approximately 96% to 98%.

PTA was identified by 31P-NMR. The main impurity was O═P(NH₂)₂OH.

It should be noted that in an industrial process, the NH₃ gas released during the second step can be reused. Similarly, the two organic solvents, namely that of the first step and that of the second step, can be collected, distilled, stripped of their traces of water and reused.

### Example 2: Efficacy of PTA as a Urea Inhibitor

Three 1500 g samples of garden soil were prepared, placed in airtight containers. One sample was treated with urea containing no PTA, and two samples with urea containing 0.1 wt % PTA. The amount of urea was the same for each sample. The PTA was the “third precipitate” within the meaning of the object of the present invention. It contained at least 75% by weight of PTA; the indication “0.1% by mass of PTA” refers here to the total mass of the third precipitate and not to the pure PTA which it contains.

Each soil sample was treated with 250 g of water before depositing the urea samples treated or not with PTA on the surface. The volatilization of urea was determined after four days, expressed in mass percent. For this, a current of air was conveyed above each sample using a membrane pump, and this air was led through a citric acid solution which fixes the ammonia by transforming it into ammonium. The citric acid solution was then titrated with a sodium hydroxide solution to calculate the amount of ammonia that had reacted with the citric acid solution. From the quantity of ammonia, the quantity of urea having generated it is calculated.

The following results were obtained:
Control sample (without PTA): 15.4%
Samples 2 and 3 (0.1% PTA): 1.5% and 3.05%

In this test, the earth was taken from a single location, and the containers were stored side by side in the same room. It can therefore be assumed that each batch was exposed to the same experimental conditions. Since the temperature of the room was not controlled (it is known that the volatilization of urea increases with temperature), and insofar as the bacterial activity of a batch of soil can change according to the place of sampling, the results of this test are not necessarily quantitatively comparable to those published in other studies on urease inhibitors. However, this test clearly demonstrates the effect of the PTA contained in the “second precipitate” on the volatilization of urea.

It should be noted that a volatilization of 15.4% without addition of PTA corresponds to an unusually low value compared to what is encountered outdoors, especially at temperatures above 20° C.: in a real site, volatilization can reach 50%.

### Example 3: Use of PTA as an Adjuvant in Nitrogen Fertilizers

PTA can be applied directly to urea-based fertilizers through a system of nozzles that allow the spray application of a precise amount of PTA per ton of fertilizer. A conveyor is used which makes it possible to determine the flow of fertilizer in tonnes and, depending on this flow, a quantity of PTA is applied which can typically range from 2 to 3 L/tonnes on the urea fertilizer granules. This application is carried out in a mixing screw thanks to several nozzles allowing the application of the PTA.

### Example 4: Comparison of Urease Inhibition Efficacy with Phosphoryl Triamide (PTA) and Thiophosphoryl Triamide (TPTA) Urea Fertilizer

Three identical samples of agricultural earth were supplied. A first sample of this earth was treated with a urea fertilizer containing 0.2% by weight of the third precipitate. This precipitate contained at least 75% by weight of PTA; the indication “0.2% by mass of PTA” refers here to the total mass of the third precipitate and not to the pure PTA which it contains. A second sample of this earth was treated with the same quantity of the same fertilizer comprising 0.2% by mass of TPTA (in the sense indicated above for PTA). The third earth sample was treated with the same amount of the same fertilizer containing no urease inhibitor. The rate of urea volatilization was determined after four days of exposure:

$$Control = 52.8 \% ; TPTA = 48.08 \% ; PTA = 19.57 \%$$

### Example 5: Determination of the Dose Effect of PTA

Following the test described in Example 4, the dose effect of the PTA was determined by treating identical agricultural earth samples with a urea fertilizer comprising 0.05%, 0.1% and 0.2% by mass of PTA (in the sense indicated above: quantity of third precipitate). The rate of urea volatilization was determined after four days of exposure: Control=45.81%; 0.05% PTA=34.19%; 0.1% PTA=29.56%; 0.02% PTA=11.55% It is noted that with 0.2% by mass of PTA the volatilization of urea is reduced by approximately 75%.

What is claimed is:

1-12. (canceled)

13. A method for manufacturing phosphoryl triamide (OP(NH₂)₃) or thiophosphoryl triamide (SP(NH₂)₃), the method comprising:
reacting phosphoryl trichloride (OPCl₃) with gaseous ammonia in an apolar liquid phase to obtain a first precipitate that comprises ammonium chloride and phosphoryl triamide or thiophosphoryl triamide; and
treating the first precipitate with sodium carbonate in a polar organic liquid phase to obtain a second precipitate that comprises NaCl in a manner such that the phosphoryl triamide remains in the polar organic liquid phase, wherein the second precipitate is separated from said polar organic liquid phase, and the concentrating the polar liquid phase to increase its concentration of phosphoryl triamide or thiophosphoryl triamide.

14. The method of claim 13, further comprising evaporating the concentrated polar liquid phase to obtain a third precipitate that comprises phosphoryl triamide or thiophosphoryl triamide.

15. The method of claim 14, wherein the third precipitate has a mass fraction of phosphoryl triamide or thiophosphoryl triamide of at least 90%.

16. The method of claim 13, further comprising performing cold recrystallization from the polar organic liquid phase to obtain a third precipitate that comprises phosphoryl triamide or thiophosphoryl triamide.

17. The method of claim 16, wherein the third precipitate has a mass fraction of phosphoryl triamide or thiophosphoryl triamide of at least 90%.

18. The method of claim 13, further comprising performing precipitation by adding an apolar solvent that comprises chloroform, from the polar organic liquid phase to obtain a third precipitate that comprises phosphoryl triamide or thiophosphoryl triamide.

19. The method of claim 18, wherein the third precipitate has a mass fraction of phosphoryl triamide or thiophosphoryl triamide of at least 90%.

20. The method of claim 13, wherein the first precipitate has a mass fraction of phosphoryl triamide or thiophosphoryl triamide of at least 28%.

21. The method of claim 13, wherein:
the apolar liquid phase is anhydrous chloroform, and/or
the polar organic liquid phase is anhydrous ethanol.

22. A product obtained using the method of claim 1.

23. The product of claim 22, further comprising evaporating the concentrated polar liquid phase to obtain a third precipitate that comprises phosphoryl triamide or thiophosphoryl triamide, wherein the product comprises the third precipitate.

24. The product of claim 23, wherein the third precipitate has a mass fraction of phosphoryl triamide or thiophosphoryl triamide of at least 90%.

25. The product of claim 22, further comprising performing cold recrystallization from the polar organic liquid phase to obtain a third precipitate that comprises phosphoryl triamide or thiophosphoryl triamide, wherein the product comprises the third precipitate.

26. The product of claim 25, wherein the third precipitate has a mass fraction of phosphoryl triamide or thiophosphoryl triamide of at least 90%.

27. The product of claim 22, further comprising performing precipitation by adding an apolar solvent that comprises chloroform, from the polar organic liquid phase to obtain a third precipitate that comprises phosphoryl triamide or thiophosphoryl triamide, wherein the product comprises the third precipitate.

28. The product of claim 27, wherein the third precipitate has a mass fraction of phosphoryl triamide or thiophosphoryl triamide of at least 90%.

29. The product of claim 22, wherein the first precipitate has a mass fraction of phosphoryl triamide or thiophosphoryl triamide of at least 28%.

30. The product of claim 13, wherein:
the apolar liquid phase is anhydrous chloroform, and/or
the polar organic liquid phase is anhydrous ethanol.

31. Use of the product of claim 22, the product being diluted in a solid formulation of nitrogen fertilizer based on urea, to: inhibit and/or regulate an enzymatic hydrolysis of urea, and/or to inhibit and/or regulate a microbiological oxidation of ammonium.

32. The use of claim 31, further comprising:
evaporating the concentrated polar liquid phase to obtain a third precipitate that comprises phosphoryl triamide or thiophosphoryl triamide, or
performing cold recrystallization from the polar organic liquid phase to obtain a third precipitate that comprises phosphoryl triamide or thiophosphoryl triamide, or
performing precipitation by adding an apolar solvent that comprises chloroform, from the polar organic liquid phase to obtain a third precipitate that comprises phosphoryl triamide or thiophosphoryl triamide,
wherein the product comprises the third precipitate.
